(19) United States
(12) Patent Application Publication
(10) Pub. No.: US 2026/0183803 A1
(43) Pub. Date: Jul. 2, 2026

(54) VEHICLE CLEANING DEVICE

(71) Applicant: Unger Marketing International, LLC, Bridgeport, CT (US)

(72) Inventors: William Harrington, Newtown, CT (US); Stephen P. Huda, Shelton, CT (US); Joseph K. Patterson, Monroe, CT (US); Bing Terry Wang, Kunshan City (CN)

(21) Appl. No.: 19/437,821

(22) Filed: Dec. 31, 2025

Related U.S. Application Data
(60) Provisional application No. 63/741,206, filed on Jan. 2, 2025.

(51) Int. Cl. B08B 1/12; B08B 1/40

(52) U.S. Cl. CPC B08B 1/12; B08B 1/40

(57) ABSTRACT

A cleaning device, such as for cleaning a vehicle, is provided. The cleaning device includes a detail portion and a handle assembly. The handle assembly includes a handle body, a middle section, and at least one gripping feature, the middle section is disposed between the handle body and the detail portion. A scrub cover is provided and is removably secured to the detail portion.

### CROSS-REFERENCE TO RELATED APPLICATIONS

This patent application claims priority to U.S. Provisional Patent Application No. 63/741,206, filed January 2, 2025, the contents of which are hereby incorporated by reference in its entirety.

### BACKGROUND

The subject matter disclosed herein relates to devices such as detail cleaning tools for vehicles, and more particularly a cleaning tool that has a flexible concave shape and may be water-fed.

Dirt and other debris frequently accumulate on windshields, windows, side mirrors, door panels, and other exterior surfaces of automobiles. Due to the type of dirt and debris that accumulate on automobiles, it can be difficult to remove. Various methods and tools may be used to clean automobiles. A common method is using a cloth or rag. This method is disadvantageous as it requires greater force to be applied by the user to scrub away the dirt and other debris and is prone to pushing debris around on the surface that is trying to be cleaned. Brushes or sponges are sometimes used. These methods too are disadvantageous as a sponge still requires greater force to be applied by the user and is not able to capture and remove larger debris. Additionally conventional brushes are inflexible and may scratch the door panels and other surfaces of the automobile. Furthermore, users become fatigued quickly by having to apply greater force when using rags or sponges.

Additionally, with all of the previously mentioned methods, the cleaning cloth gets dirty and contaminated as it is used and the user must repeatedly use their hand to dip the cleaning cloth into a bucket or other external source of water to rinse off the dirt and replenish the tool with water/cleaning solution. As such, the use of a cleaning cloth for cleaning exterior surfaces of automobiles is inefficient.

Accordingly, it is desirable to provide a cleaning device that provides sufficient rigidity to scrub away of the dirt and debris having features described herein.

### BRIEF DESCRIPTION

According to an embodiment, a cleaning device is provided. The cleaning device includes a detail portion defining a concave shape. The detail portion includes a first pair of fins and a second pair of fins, the first pair of fins and the second pair of fins being formed into opposing ends of the detail portion. The detail portion includes a first raised portion and a second raised portion spaced from each other and between the pair of fins, the first raised portion and the second raised portion defining a trench therebetween. The cleaning device includes a handle assembly having a handle body, a middle section, and at least one gripping feature, the middle section disposed between the handle body and the detail portion. The cleaning device includes a scrub cover removably secured to the detail portion.

In addition to one or more of the features described above, or as an alternative, in further embodiments the cleaning device may include each of the pair of fins defining a slot therebetween.

In addition to one or more of the features described above, or as an alternative, in further embodiments the cleaning device may include that the detail portion is flexible.

In addition to one or more of the features described above, or as an alternative, in further embodiments the cleaning device may include that the handle body further includes a cavity formed in a top and middle portion of the handle body and a first end including a recess having a threaded counter bore configured to couple to a water source, wherein the cavity and the recess are in fluid communication.

In addition to one or more of the features described above, or as an alternative, in further embodiments the cleaning device may include that the middle portion includes a first end including a connecting portion, a tube connected to the connecting portion and extending through the middle section in a longitudinal direction, along a longitudinal axis, and a second end including a first protrusion and a second protrusion extending from the second end perpendicular to the longitudinal axis, the first protrusion and the second protrusion being diametrically opposed.

In addition to one or more of the features described above, or as an alternative, in further embodiments the cleaning device may include that the middle section further includes an opening formed in the second end or an opening formed in the first and the second protrusion.

In addition to one or more of the features described above, or as an alternative, in further embodiments the cleaning device may include that the cavity and the recess are in fluid communication with the tube and the opening formed in the second end or the opening formed in the first protrusion and the second protrusion.

In addition to one or more of the features described above, or as an alternative, in further embodiments the cleaning device may include that the first protrusion and the second protrusion are rotatably coupled to the first raised portion and the second raised portion.

In addition to one or more of the features described above, or as an alternative, in further embodiments the cleaning device may include that the scrub cover is configured to slide over and conform to the detail portion and have substantially the same shape as the detail portion.

In addition to one or more of the features described above, or as an alternative, in further embodiments the cleaning device may include a flow regulator in fluid communication with the detail portion.

In addition to one or more of the features described above, or as an alternative, in further embodiments the cleaning device may include that each pair of fins is flexible.

According to an embodiment, a cleaning device is provided. The cleaning device includes a detail portion defining a concave shape. The detail portion includes a first pair of fins and a second pair of fins, the first pair of fins and the second pair of fins being formed into opposing ends of the detail portion. The detail portion includes a first raised portion and a second raised portion spaced from each other and between the pair of fins, the first raised portion and the second raised portion defining a trench therebetween. The cleaning device includes a handle assembly having a handle body including a first end including a recess having a threaded counter bore configured to couple to a water source and a cavity formed in a top and middle portion, and a middle section, the middle section disposed between the handle body and the detail portion, wherein the cavity and the recess are in fluid communication.

In addition to one or more of the features described above, or as an alternative, in further embodiments the cleaning device may include that the handle assembly further includes at least one gripping feature forming about a periphery of the handle body.

In addition to one or more of the features described above, or as an alternative, in further embodiments the cleaning device may include that each of the pair of fins define a slot therebetween.

In addition to one or more of the features described above, or as an alternative, in further embodiments the cleaning device may include that the detail portion is flexible

In addition to one or more of the features described above, or as an alternative, in further embodiments the cleaning device may include that the middle section includes a first end including a connecting portion, a tube connected to the connecting portion and extending through the middle section in a longitudinal direction, along a longitudinal axis, and a second end including a first protrusion and a second protrusion extending from the second end perpendicular to the longitudinal axis, the first protrusion and the second protrusion being diametrically opposed.

In addition to one or more of the features described above, or as an alternative, in further embodiments the cleaning device may include that the tube includes a tapered body.

In addition to one or more of the features described above, or as an alternative, in further embodiments the cleaning device may include that the tube, the cavity, and the recess are in fluid communication.

In addition to one or more of the features described above, or as an alternative, in further embodiments the cleaning device may include a flow regulator in fluid communication with the detail portion.

In addition to one or more of the features described above, or as an alternative, in further embodiments the cleaning device may include that each pair of fins is flexible.

### BRIEF DESCRIPTION OF THE DRAWINGS

The following descriptions should not be considered limiting in any way. With reference to the accompanying drawings, like elements are numbered alike:

FIG. 1 is a top perspective view of a cleaning device;

FIG. 2 is an bottom perspective view of the cleaning device of FIG. 1 according to an embodiment;

FIG. 3 is an unassembled view of the cleaning device of FIG. 1 according to an embodiment;

FIGS. 4A and 4B is a front and back side view of the cleaning device of FIG. 1 according to an embodiment;

FIGS. 5A and 5B is a left and right view of the cleaning device of FIG. 1 according to an embodiment;

FIG. 6 is a cross-sectional view of the cleaning device of FIG. 1 according to an embodiment;

FIG. 7 is a top view of the cleaning device of FIG. 1 according to an embodiment;

FIGS. 8A-8C is a top, left-side, and right-side view of a cover or cloth for the cleaning device of FIG. 1 according to an embodiment; and

FIG. 9 is a top perspective view of the cleaning device of FIG. 1 according to an embodiment.

### DETAILED DESCRIPTION

Proper contact between the cleaning device and an exterior surface of a vehicle (e.g., automobile) can affect performance of treatment. However, proper contact can be difficult, depending on the curvature, or lack thereof, of the cleaning device and of the surface being cleaned. Improper contact may lead to diminished effectiveness. For example, the surface is not being cleaned because of the improper contact. In some instances, additional force may need to be applied to scrub the surface clean due to the incompatible surface curvature of the cleaning device and the automobile surface curvature. Further, proper contact of the cleaning device over certain exterior surfaces of an automobile (e.g. on a windshield, door panel, and trunk) are difficult due to the contour of the areas. Accordingly, difficulties in proper contact may lead to a decrease in the performance of the cleaning device. Accordingly, a way to assist with proper contact, a contoured cleaning device that has flex is desirable.

The inventors have discovered that utilizing a cleaning device with a cleaning surface that has a contoured shape and is flexible may facilitate and enable proper contact between the cleaning device and the surface of the automobile and may improve the effective cleaning of the cleaning device on an exterior surface of an automobile.

Further, as recognized by the inventors, the cleaning device with a cleaning surface that includes fins or tabs on opposing ends of the cleaning surface may help improve the flexibility of the cleaning device. The inventors discovered the fins or tabs may allow the cleaning surface to flex until it is flat or substantially flat.

Additionally, automobile cleaning devices typically require a continuous water supply. Conventionally, the cleaning device must be repeatedly dipped into a bucket of water to clean built up debris and dirt on the cleaning device and to replenish the water/cleaning solution, which can be undesirable for many reasons. For example, a bucket or other external source of water must be dragged around by the user and must also be periodically emptied and replenished as it becomes saturated with debris and dirt. The inventors have discovered that configuring the cleaning device to be coupled to a water source, such as a hose or water fed pole, and utilizing strategically placed cavities throughout the cleaning device eliminates the need to repeatedly dip the cleaning device into a bucket or other external source of water to rinse off the dirt and replenish the tool with water/cleaning solution.

As described herein, reference to a vehicle includes any vehicle surface – for example, but not limited to, a window – that is cleaned, such as, but not limited to, a truck, a sedan, an SUV, a motorcycle, a snowmobile, an airplane, a boat, or a personal watercraft.

A detailed description of one or more embodiments of the disclosed apparatus and method are presented herein by way of exemplification and not limitation with reference to the Figures.

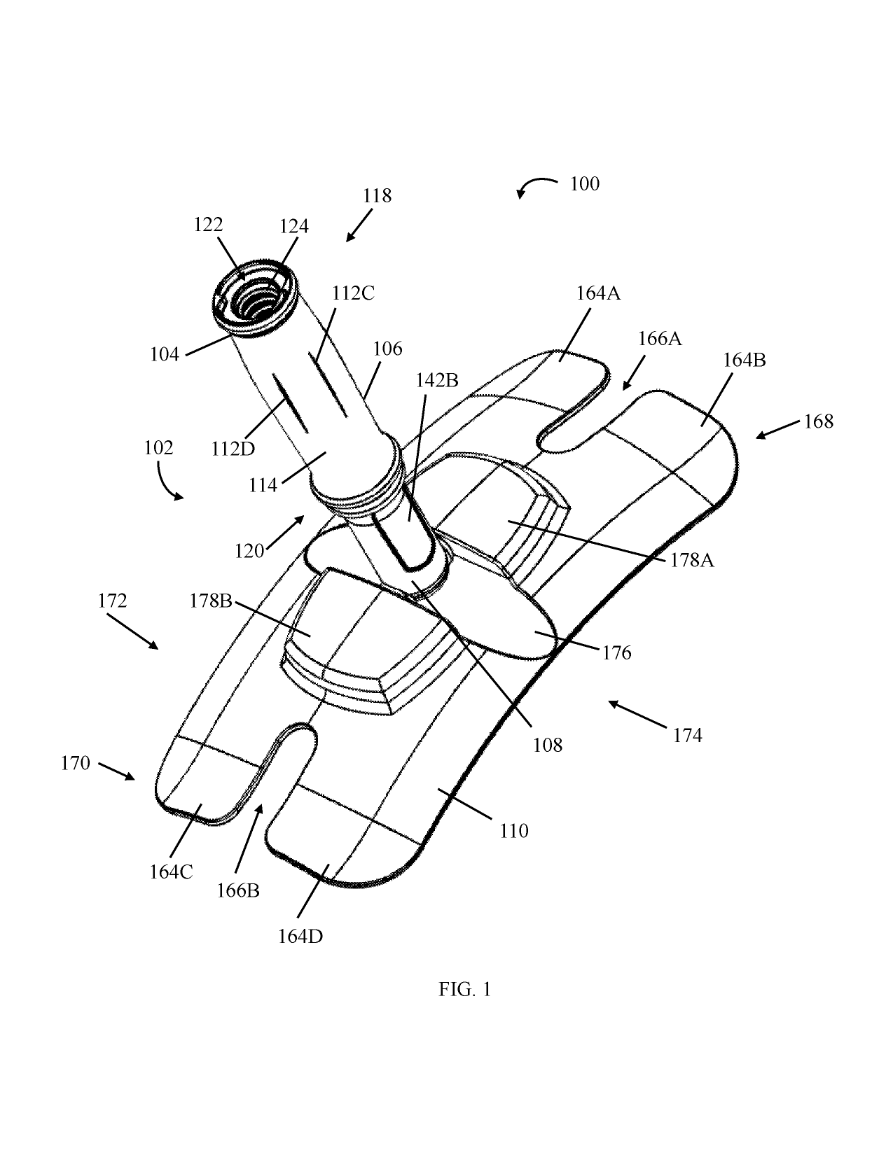

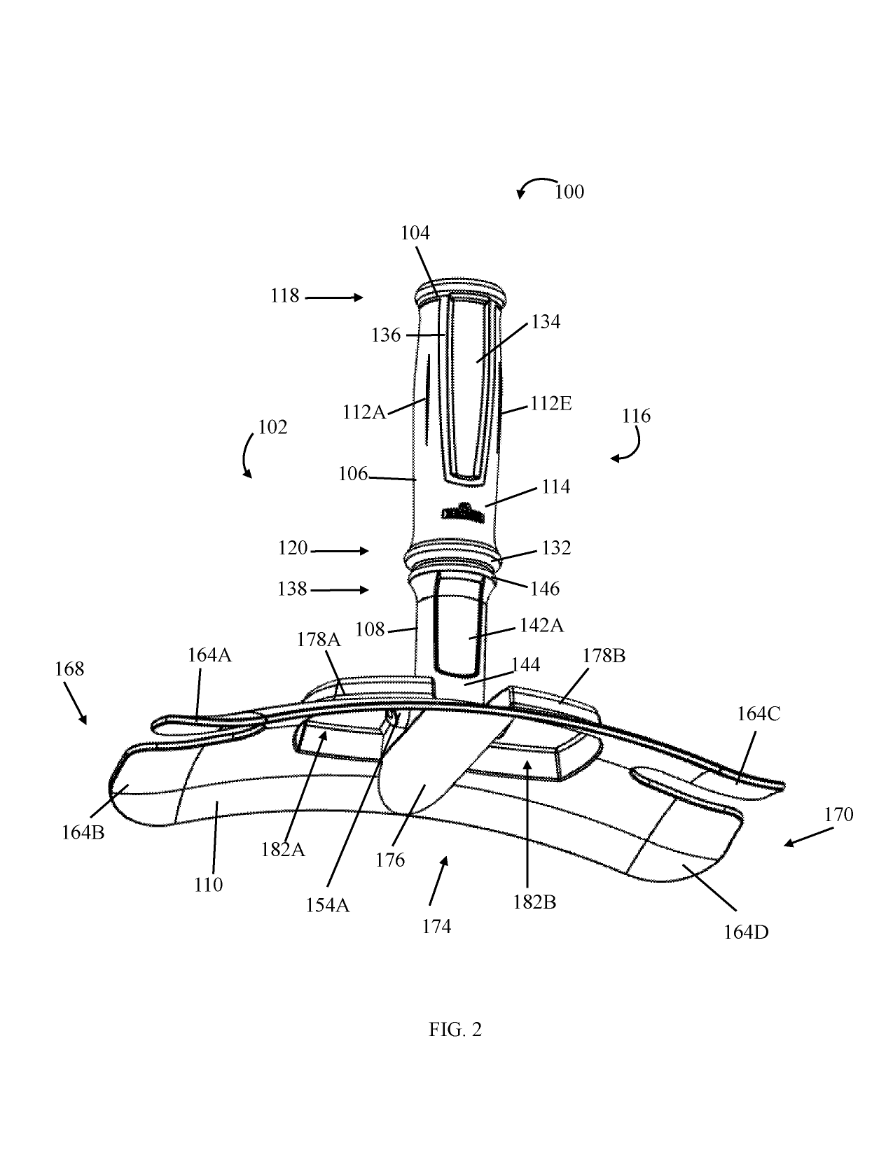

FIG. 1 is a top perspective view of a cleaning device and FIG. 2 is an bottom perspective view of the cleaning device of FIG. 1 according to an embodiment The cleaning device 100 includes a handle assembly 102 having a handle body 104, at least one gripping feature 106, and a middle section 108. The device 100 can be grasped by the handle body 104 and manipulated such that a detail portion 110 of the device 100 may be scrubbed against a surface of a vehicle, such as the windshield or door panel. Additionally, the device 100 may be configured such that the handle body 104 can be secured to an extension pole/handle, a water-fed pole/handle, and/or a hose connected to a water-supply (not shown) in a manner such as, but not limited to, a threaded connection, a press-fit connection, or a locking connection.

As shown in FIGS. 1 and 2, the at least one gripping feature 106 may be mounted or co-molded to the handle body 104. The gripping feature 106 may be formed to an outer surface of the handle body 104 and wraps about the entire periphery of the handle body 104. The gripping feature 106 may be positioned and designed to facilitate a user's grasp about the handle body 104. For example, the gripping feature 106 may include at least one elongate rib 112A extending generally parallel to a longitudinal axis X of the device 100. In some embodiments, the gripping feature 106 may include a plurality of elongate ribs 112A, 112B, 112C, 112D, 112E. In the illustrated, non-limiting embodiment, a plurality of elongate ribs 112A-112E are spaced substantially equidistant about a periphery of the handle body 104. A surface 114 of the gripping feature 106 in between the plurality of elongate ribs 112A-112E may be a substantially smooth surface. In some embodiments, the surface 114 of the gripping feature 106 in between the plurality of elongate ribs 112A-112E may be a textured surface, for example a series of bumps or ridges. The textured surface may provide improved graspability of the handle body 104 be increasing the friction points between the user's hand and the gripping feature 106.

In some embodiments, the entire surface 114 of the gripping feature 106 may include a substantially smooth surface. Alternatively, the entire surface 114 of the gripping feature 106 may include the textured surface. In some embodiments, the gripping feature 106 may include at least one groove (not pictured) arranged within a plane substantially perpendicular to the longitudinal axis X, such that the groove wraps about at least a portion of the gripping feature 106, and in some embodiments an entirety, of the periphery of the gripping feature 106. It should be appreciated that the gripping features 106 illustrated and described herein are intended as an example only and that a gripping feature 106 having any suitable configuration is within the scope of the disclosure. Furthermore, embodiments where the handle body 104 does not include any gripping features 106 are also within the scope of the disclosure.

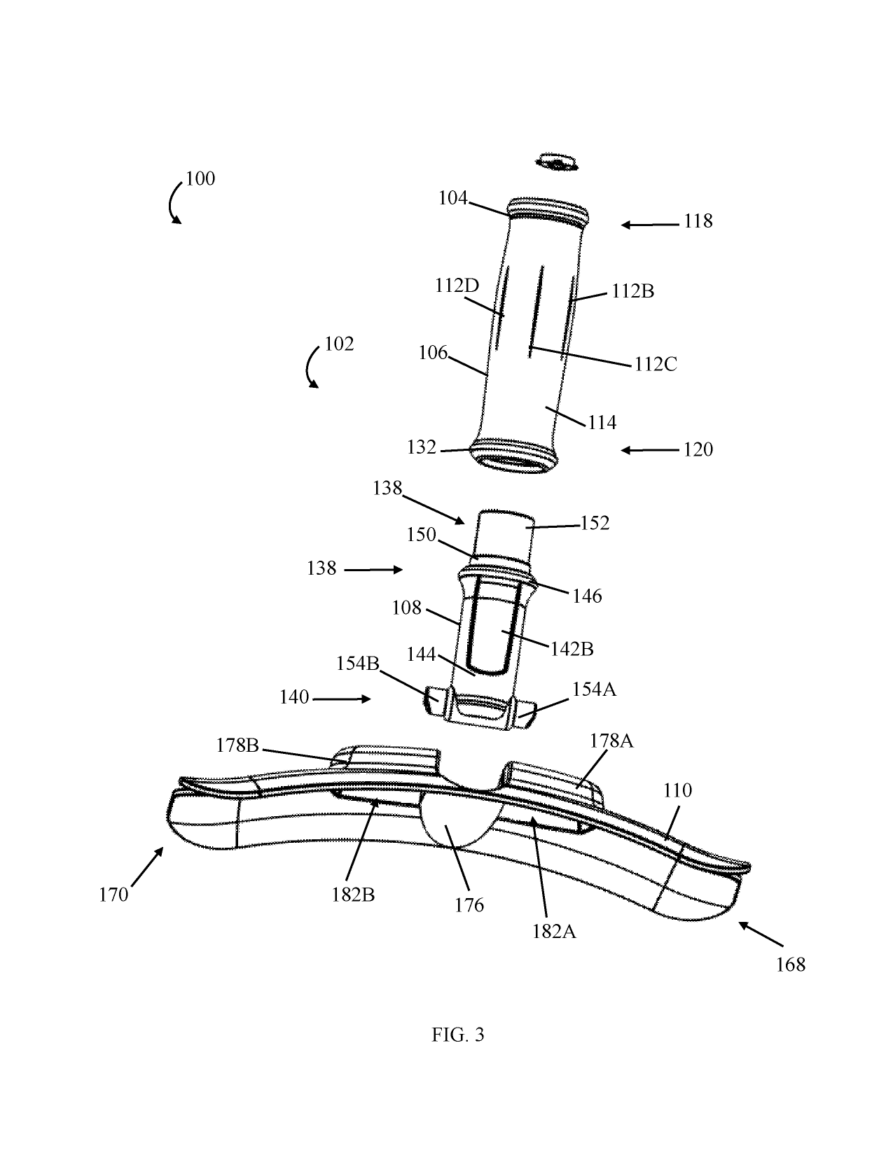

In some embodiments, the handle body 104 may include a divot or indent 134 on a front side 116 of the handle body 104 (FIG. 3). The gripping feature 106 may be formed to the outer surface of the handle body 104 and wraps about the entire periphery of the handle body 104 to a perimeter 136 of the indent 134. The indent 134 may be rectangular shaped, substantially rectangular shaped, oval shaped, substantially oval shape, ovoid shaped, substantially ovoid shaped, rounded triangular shaped, or substantially rounded triangular shaped. The indent 134 may extend from a first end 118 of the handle body 104 and extend lengthwise up the handle body 104 in a longitudinal direction, parallel to the longitudinal axis X. In some embodiments, the indent 134 may extend along one third the length of the handle body 104. In some embodiments, the indent 134 may extend along one half the length of the handle body 104. In yet other embodiments, the indent 134 may extend along two thirds the length of the handle body 104. The indent 134 may be sized to house the full or substantially the full width and length of the user's thumb. The indent 134 may enable the user to maintain a stronger hold on the device. The indent 134 creates an ergonomic shape in the handle body 104 and acts as an anchor point for a user's phalange, for example the thumb, providing a more stable grip on the handle body 104.

The handle body 104 may further include second end 120 having a diameter that progressively increases such that it forms a lip 132. The lip 132 may act as a stopper to prevent the user's hand from sliding off the handle body 104 and butting against the detail portion 110 during use. A detail portion 110 extends from the second end 120 of the handle body 104 with the middle section 108 disposed therebetween.

The detail portion 110 may have a rectangular shape, a substantially rectangular shape, a rounded-rectangular shape, a substantially rounded-rectangular shape, an ovoid shape, or a substantially ovoid shape. In some embodiments, the detail portion 110 may have a concave shape away from the handle assembly 102 such that the handle assembly 102 couples to the detail portion 110 near or at the apex. In some embodiments, the detail portion 110 may include a pair of fins 164A, 164B spaced a distance from each other on a first end 168 and a second pair of fins 164C, 164D spaced a distance from each other on a second end 170. The first pair of fins 164A, 164B may define a slot 166A (e.g., a U-shaped slot) therebetween. The second pair of fins 164C, 164D may define a slot 166B (e.g., U-shaped slot) therebetween. The fins 164A-D give the detail portion 110 greater range of flexibility such that the detail portion 110 may flex until it is substantially flat or flat. In some instances, the slot 166 may encourage additional flexibility of the corresponding fins 164. In some instances, a portion of the detail portion 110 may define a first flexibility in proximity to the longitudinal axis X and a second flexibility in proximity to the pair of fins 164A-D. In some instances, the second flexibility has an increased flexibility compared to the first flexibility.

In some embodiments, the detail portion 110 includes a trench 176. The trench 176 may have an ovoid, a substantially ovoid, an oval, a substantially oval, oblong, or a substantially oblong shape and positioned substantially center of the detail portion 110 and traverses the longitudinal axis X. In some embodiments, the trench 176 may extend the full width of the detail portion 110, having a length equal to the width of the detail portion 110, spanning between a first long side 172 and a second long side 174. In some embodiments, the trench 176 may have a length less than the width of the detail portion 110. The detail portion 110 may further include a first raised portion 178A and a second raised portion 178B positioned on opposing sides of the trench 176. The first and the second raised portion 178A, 178B may have a square shape, a rounded square shape, a rectangular shape, a rounded rectangular shape, a circular shape, or an oblong shape. The first and the second raised portion 178A, 178B include an opening (not pictured) along the trench 176 and parallel to a latitudinal axis Y.

FIG. 3 is an unassembled view of the cleaning device of FIG. 1 according to an embodiment. The middle section 108 may be removably or permanently coupled to the handle body 104 and may be rotatably coupled to the detail portion 110. The middle section 108 may be substantially cylindrical in shape with a consistent diameter. The middle section 108 may have a diameter dimensioned smaller than a diameter of the handle body 104. In some embodiments the middle section 108 may have a diameter substantially equal to the diameter of the handle body 104. In some embodiments, the middle section 108 may include a first end 138 having a diameter that progressively increases such that it forms a corresponding lip 146 to the lip 132 of the handle body 104.

In some embodiments, the middle section 108 may be substantially cylindrical with a tapered shape such that a diameter of the first end 138 is greater than a diameter of a second end 140, and the diameter of the middle section 108 progressively decreases in size from the first end 138 to the second end 140, i.e. from the end couple to the handle body 104 to the end coupled to the top side 180 of the detail portion 110.

The middle section 108 may include a connecting portion 148 extending from the first end 138, the connecting portion 148 having a diameter dimensioned smaller than a diameter of the lip 146 and a diameter of the first end 138. The connecting portion 148 may comprise of a step diameter where a lower section 150 has a diameter dimensioned larger than a diameter of an upper section 152, the upper section 152 being longer than the lower section 150. In some embodiments, the connecting portion 148 is hollow as well as the entire middle section 108 is hollow. In some embodiments, the connecting portion 148 is a solid piece.

The middle section 108 is coupled to the handle body 104 via the connecting portion 148. As described above, the connecting portion 148 may be permanently coupled to the handle body 104 or may be removably coupled to the handle body 104. The handle body 104 may further include a hollow interior defining a cavity 126 formed in a top portion 128 and a middle portion 130 of the handle body 104. The connecting portion 148 of the middle section 108 may be inserted into the cavity 126 of the handle body 104. The upper section 152 of the connecting portion 148 and the cavity 126 may each have diameters dimensioned substantially equal such that a friction fit is formed. In some embodiments, the handle assembly 102 and the middle section 108 may further form a connection via a snap-fit connection. For example, but not limited to, the second end 120 of the handle body 104 may include a indent formed in an interior surface corresponding to the lower section 150 of the connecting portion 148. The lower section 150 may "snap" into the indent formed in the handle body 104.

As described above, the middle section 108 may be rotatably coupled to the detail portion 110. The second end 140 of the middle section 108 may include at least one protrusion 154A. The at least one protrusion 154A may extend from the middle section 108 perpendicular to a longitudinal axis X of the device 100, and may be substantially cylindrical in shape. The at least one protrusion 154A inserts into a corresponding opening in the first and the second raised portions 178A, 178B of the detail portion 110. The cylindrical shape allows the at least one protrusion 154A to freely rotate in the corresponding opening. In some embodiments, the first end 138 of the middle section 108 includes a first protrusion 154A and a second protrusion 154B. The first protrusion 154A and the second protrusion 154B extend from the middle section 108 perpendicular from the longitudinal axis X on opposite sides of the middle section 108, the first protrusion 154A and the second protrusion 154B being diametrically opposed. The first protrusion 154A and the second protrusion 154B insert into a corresponding opening, respectively, in the first and the second raised portions 178A, 178B of the detail portion 110.

As described above, the detail portion 110 defines a trench 176 with a first raised portion 178A and a second raised portion 178B positioned on opposing sides of the trench 176. The first and the second raised portion 178A, 178B include an opening (not pictured) along the trench 176 and parallel to the latitudinal axis Y. The second end 140 of the middle section 108 rests within the trench and the first protrusions 154A and the second protrusions 154B couple to the openings of the first and the second raised portion 178A, 178B. The first protrusion 154A and the second protrusion 154B may rotate freely with in the openings. The handle assembly 102 rotates along the latitudinal axis Y plane.

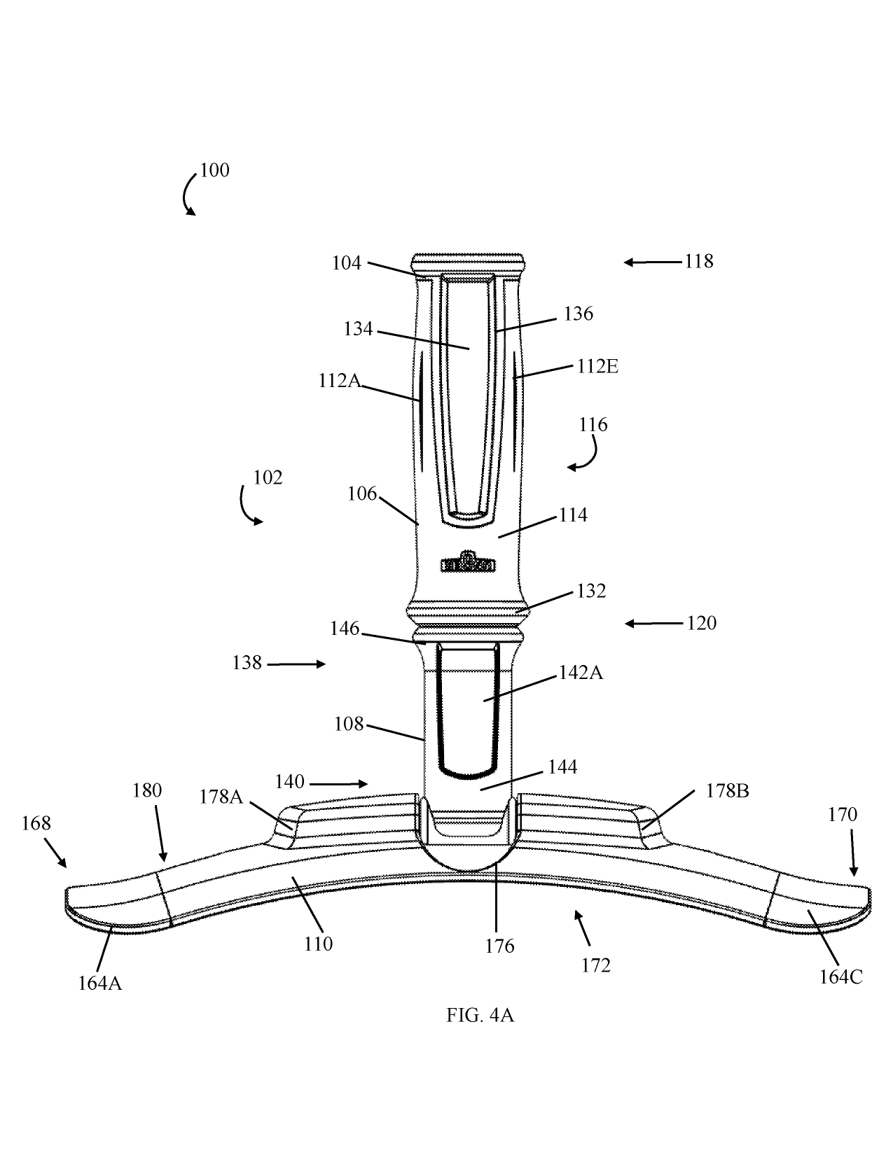

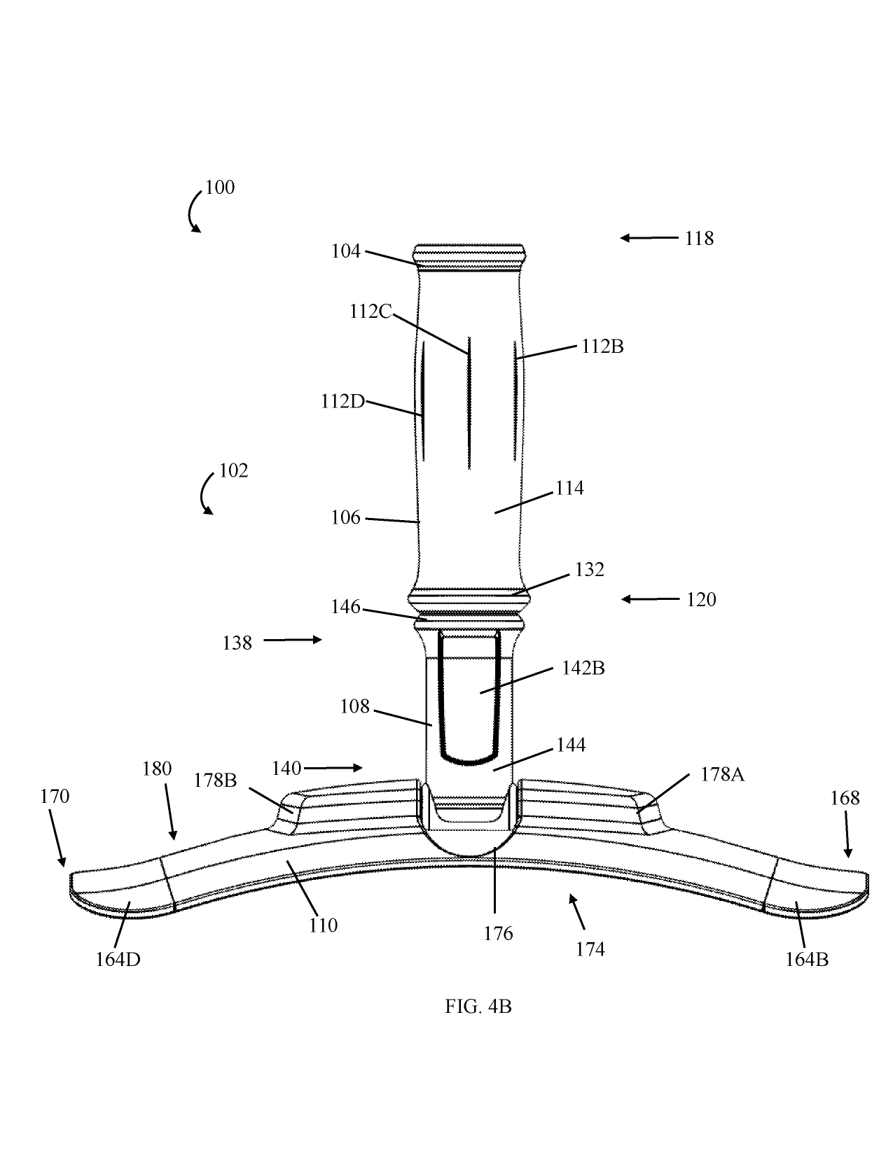

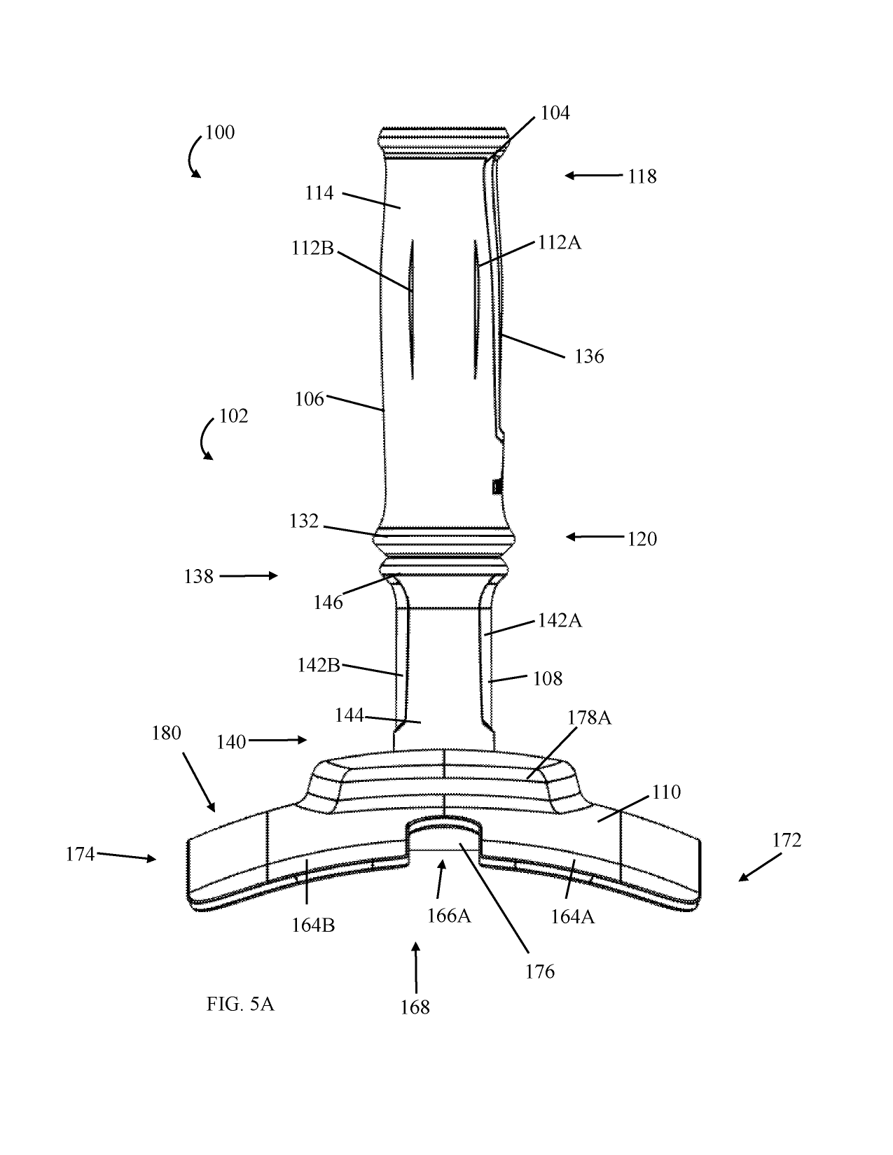

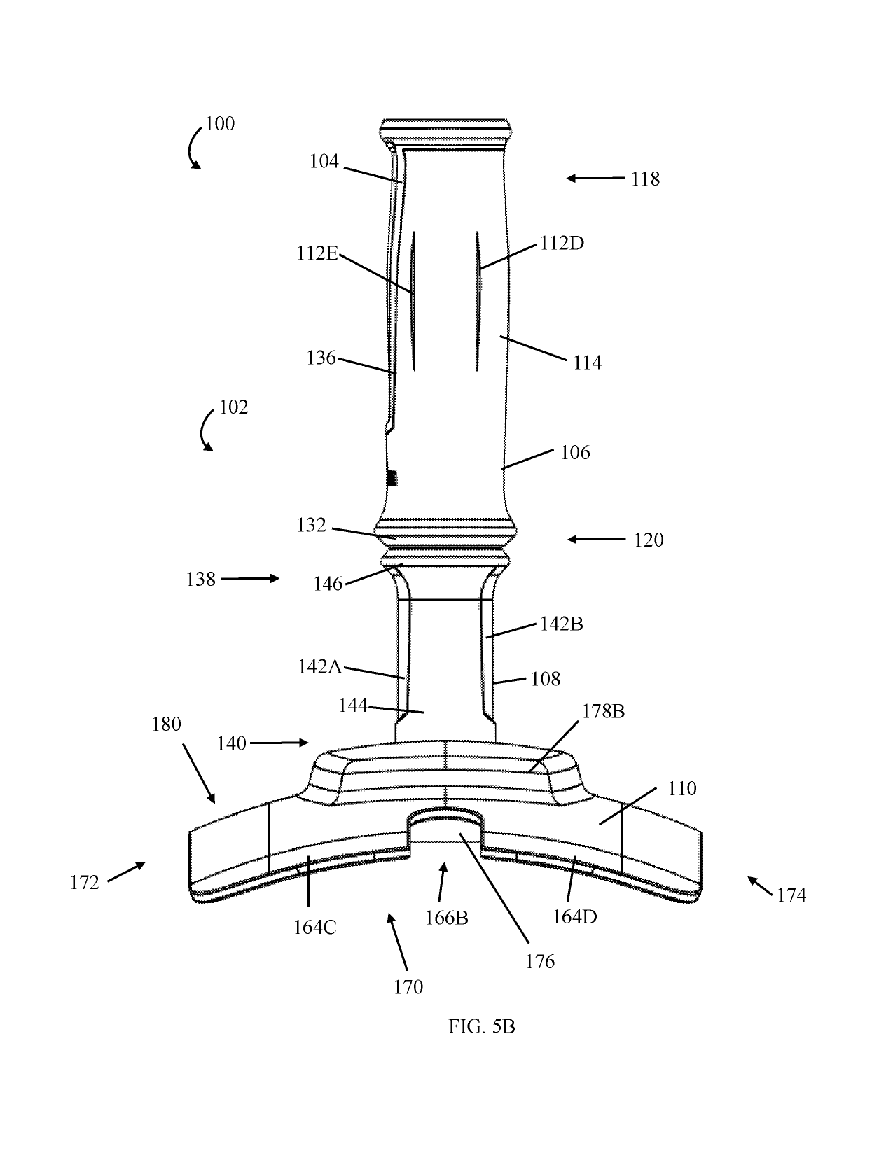

FIGS. 4A and 4B is a front and back side view and FIGS. 5A and 5B is a left and right view of the cleaning device of FIG. 1 according to an embodiment. In some embodiments, the middle section 108 may include at least one void 142A formed on a surface 144 of the middle section 108. In some embodiments, the middle section 108 includes a first void 142A and a second void 142B. The first void 142A and the second void 142B are located on opposite sides of the middle section 108. The first void 142A and the second void 142B are diametrically opposed. As shown in FIGS. 4A and 4B, the second end 140 of the middle section 108 is positioned within the trench 176 with space between the surface of the trench 176 and the second end 140.

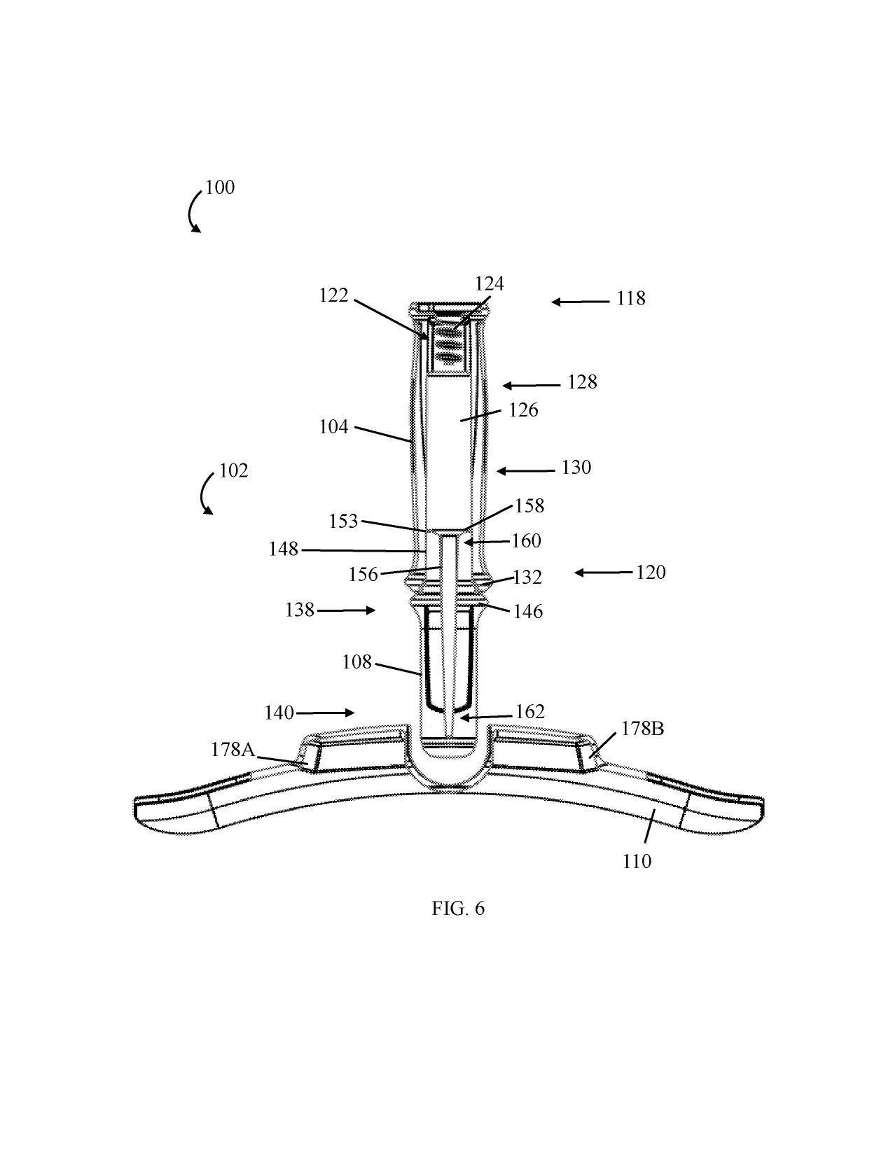

FIG. 6 is a cross-sectional view of the cleaning device of FIG. 1 according to an embodiment. The first end 118 of the handle body 104 may include a recess 122 having a threaded counter bore 124 to secure the device 100 to a water source, such as, but not limited to, a water device, a water-fed pole, or a water hose (connected to a water-source, not shown). In some embodiments, the threaded counter bore 124 may be used for a water-fed pole or water-fed hose, which provides liquids, such as, but not limited to, water or a cleaning solution, directly into or at the detail portion 110. Running water may be fed from a water-fed pole or water-fed hose to the device 100 to clean exterior surfaces of an automobile. In this way, the device 100 can used to clean automobile exterior surfaces, while water is supplied to the device 100, thereby removing the need to consistently dip the cleaning device into a bucket or other external source of water to rinse off the dirt and replenish the tool with water/cleaning solution.

As described above, the handle body 104 may include a hollow interior defining a cavity 126 formed in a top portion 128 and a middle section 108 of the handle body 104, extending toward the recess 122. The cavity 126 may have substantially the same shape as the handle body 104. The recess 122 and cavity 126 may be in fluid communication such that when a water source is coupled to the threaded counter bore 124, water may flow into the cavity 126.

The connecting portion 148 is inserted into the top portion 128 of the handle body 104. As shown in FIG. 6, the middle section 108 may further include a hollow tube 156. The tube 156 may be positioned substantially center in the middle section 108, extending from an outer edge 153 of the connecting portion 148 to the second end 140 of the middle section 108. The outer edge 153 of the connecting portion 148 may include a wall 158, extending from a perimeter of the connecting portion 148 to a perimeter of the tube 156. The wall 158 separates the cavity 126 from the connecting portion 148 while keeping the tube 156 in fluid communication with the cavity 126. The wall 158 and the tube 156 may be integrally formed. Additionally, the tube 156 may be integrally formed with the second end 140 of the middle section 108.

The tube 156 may have a progressively decreasing diameter from a first end 160 to a second end 162. The progressively decreasing diameter allows for improved water flow control from the water source to the detail portion 110 and inhibits excess water from saturating the detail portion 110. Accordingly, the recess 122, cavity 126, and middle section 108 place the detail portion 110 in fluid communication with a water source.

In some embodiments, the second end 140 of the middle section 108 may include an opening transversing the longitudinal axis that is in fluid communication with the tube 156. Accordingly, water may be fed to the device 100 and travel through the cavity 126 into the tube 156 and out of the opening in the second end 140 of the middle section 108 to disperse the water to the detail portion 110 during cleaning. In this embodiment, water may pool in the trench 176 wherein the trench 176 allows water to disperse to the first long side 172 and the second long side 174 of the detail portion 110, thereby uniformly saturating the detail portion 110 with water. In some embodiments, the first protrusions 154A and the second protrusion 154B may include openings that are in fluid communication with the tube 156. Accordingly, water may be fed to the device 100 and travel through the cavity 126 into the tube 156 and out of the opening in the first protrusion 154A and the second protrusion 154B. In this embodiment, water is fed to a cavity 182A, 182B of the first raised portion 178A and the second raised portion 178B. The cavities 182A, 182B allow water to disperse to the first end 168 and the second end 170 of the detail portion 110, thereby uniformly saturating the detail portion 110 with water. In some embodiments, the device 100 includes the opening in the second end 140 of the middle section 108 and the openings in the first protrusions 154A and the second protrusion 154B. Those of skill in the art will appreciate that any combination or single implementation of the above described fluid distribution may be employed without departing from the scope of the present disclosure.

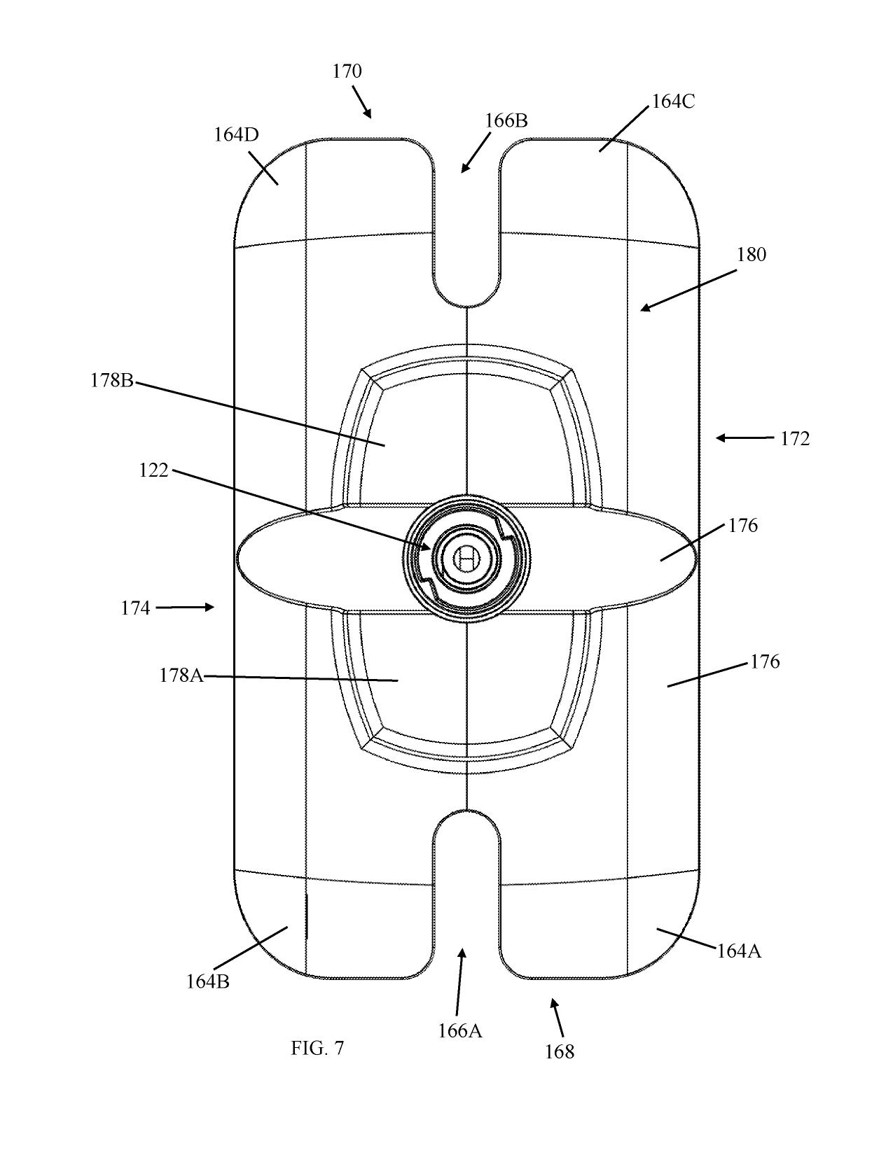

FIG. 7 is a top view of the cleaning device of FIG. 1 according to an embodiment. In some embodiments, the latitudinal axis Y intersects a centroid of the handle body 104, as illustrated in FIG. 7. The handle body 104 may have a substantially cylindrical shape and a diameter that is dimensioned larger than a width of the trench 176. The first and the second raised portion 178A, 178B are mirror image of each other, on either side of the latitudinal axis Y.

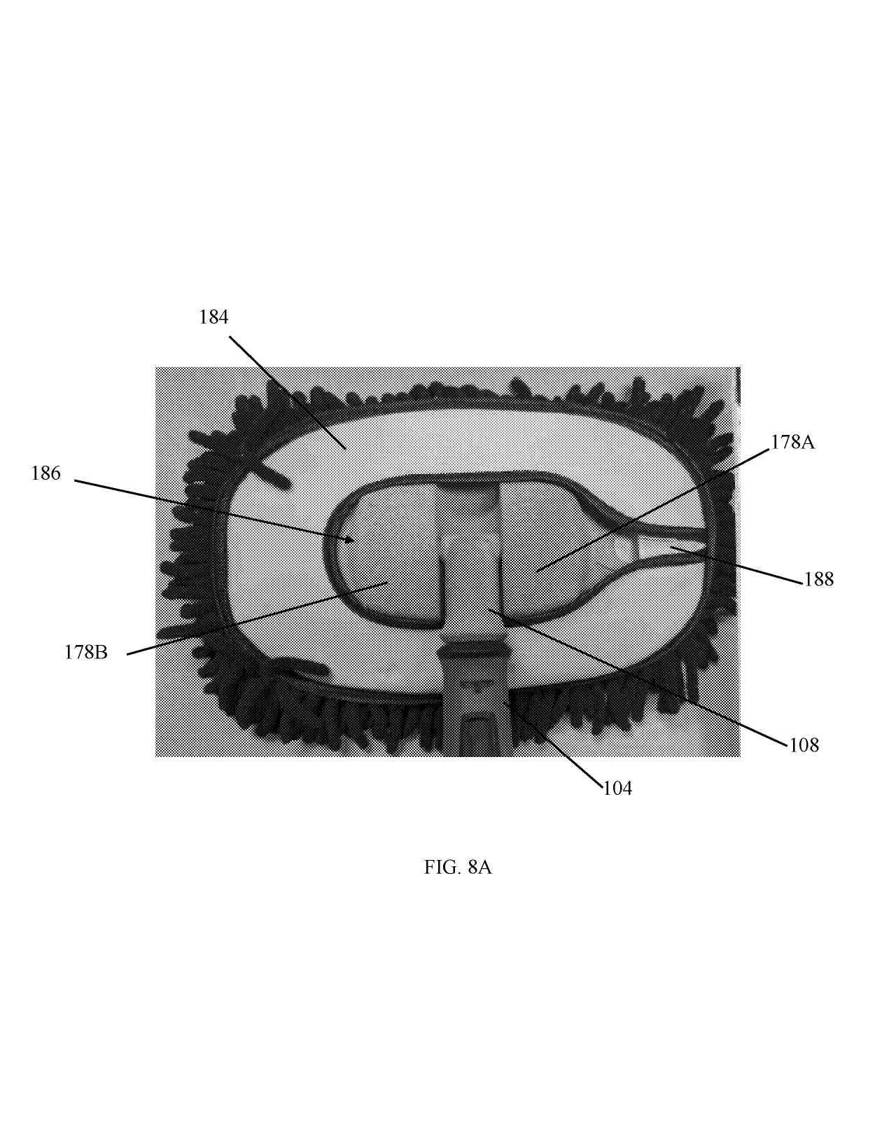

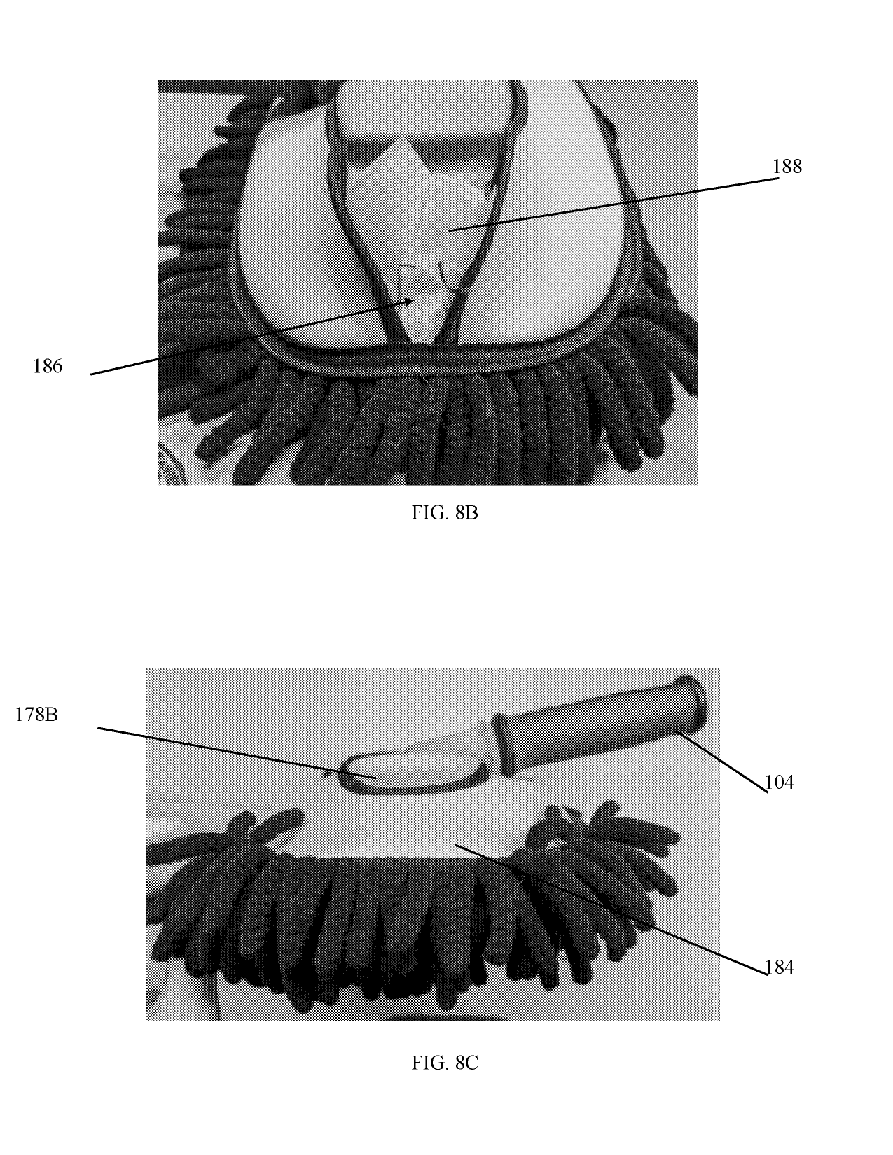

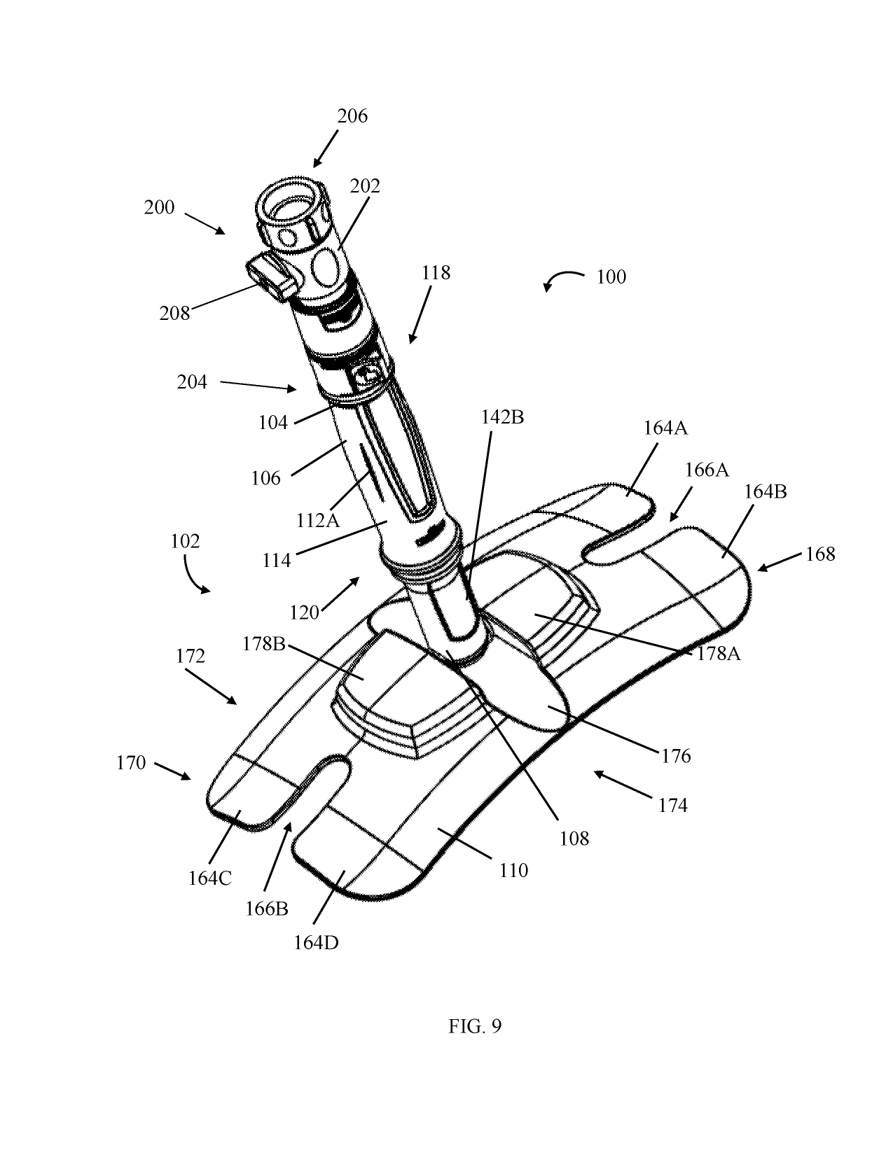

The device 100 may further include a removable cleaning brush 184 or cloth/sleeve or scrub cover as shown in FIGS. 8A-8C. The removable cleaning brush 184 may have a hollow interior with an opening 188 formed in the top such that it may be slide over the detail portion 110 and conform to the detail portion 110 with the first and the second raised portion 178A, 178B and handle assembly 102 extending out of the opening 188 of the cleaning brush 184. The cleaning brush 184 may be shaped to have substantially the same shape as the detail portion 110. In some embodiments, the cleaning brush 184 may include a textured surface, for example a series of bump. The cleaning brush 184 may be secured to the detail portion 110 via a fastener 186, for example, but not limited to, a hook and loop fastener, a press-fit connection, or a friction fit. For example, as shown in FIG. 8B, once the device 100 is inserted into the cleaning brush 184, a hook and loop fastener is coupled to secure the cleaning brush 160 to the detail portion 110. Water saturates the cleaning brush 184 as it flows through a recess 122, a cavity 126, the middle section 108, and the tube 156 out of the middle section 108, as described above.

FIG. 9 is a perspective view of the cleaning device of FIG. 1 according to an embodiment. In some embodiments, the cleaning device 100 includes a flow control regulator mounted in fluid communication with the first end 118 of the handle body 104. The flow control regulator 200 includes a body 202 defined by a first end 204 and a second end 206 opposite from the first end 204. The first end 204 of the body 202 may be removably coupled to the handle body 104. For example, the first end 204 of the body 202 may be removably coupled to the threaded counter bore 124 of the handle body 104. The flow control regulator 200 may be configured to provide automatic, semi-automatic, or manual regulation of the water and/or cleaning solution delivery to the detail portion 110. In some instances, the flow control regulator 200 may include a dial 208 configured to adjust the flow of the water and/or cleaning solution. Adjustment of the flow of the water and/or cleaning solution may include reducing, increasing, or stopping the flow. Instances where the flow control regulator 200 is configured to automatically or semi-automatically adjust the flow of the water and/or the cleaning solution, the dial 208 may also be used to adjust the flow.

In an embodiment, the first end 204 and the handle body 104 may be configured to couple using the locking system described in commonly owned United States Patent US8745837B2 entitled “Locking system for connecting poles and tools”, the contents of which are incorporated herein by reference.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A cleaning device comprising:
a detail portion defining a concave shape, the detail portion comprising:
a first pair of fins and a second pair of fins, the first pair of fins and the second pair of fins being formed into opposing ends of the detail portion;
a first raised portion and a second raised portion spaced from each other and between the pair of fins, the first raised portion and the second raised portion defining a trench therebetween; and
a handle assembly having a handle body, a middle section, and at least one gripping feature, the middle section disposed between the handle body and the detail portion; and
a scrub cover removably secured to the detail portion.

2. The cleaning device of claim 1, wherein each of the pair of fins define a slot therebetween.

3. The cleaning device of claim 1, wherein the detail portion is flexible.

4. The cleaning device of claim 1, wherein the handle body further comprises a cavity formed in a top and middle portion of the handle body and a first end including a recess having a threaded counter bore configured to couple to a water source, wherein the cavity and the recess are in fluid communication.

5. The cleaning device of claim 4, wherein the middle section further comprises:
a first end including a connecting portion;
a tube connected to the connecting portion and extending through the middle section in a longitudinal direction, along a longitudinal axis; and
a second end including a first protrusion and a second protrusion extending from the second end perpendicular to the longitudinal axis, the first protrusion and the second protrusion being diametrically opposed.

6. The cleaning device of claim 5, wherein the middle section further comprises an opening formed in the second end or an opening formed in the first and the second protrusion.

7. The cleaning device of claim 6, wherein the cavity and the recess are in fluid communication with the tube and the opening formed in the second end or the opening formed in the first protrusion and the second protrusion.

8. The cleaning device of claim 5, wherein the first protrusion and the second protrusion are rotatably coupled to the first raised portion and the second raised portion.

9. The cleaning device of claim 1, wherein the scrub cover is configured to slide over and conform to the detail portion and have substantially the same shape as the detail portion.

10. The cleaning device of claim 1 further comprising a flow regulator in fluid communication with the detail portion.

11. The cleaning device of claim 2, wherein each pair of fins is flexible.

12. A cleaning device comprising:
a detail portion defining a concave shape, the detail portion comprising:
a first pair of fins and a second pair of fins, the first pair of fins and the second pair of fins being formed into opposing ends of the detail portion;
a first raised portion and a second raised portion spaced from each other and between the pair of fins, the first raised portion and the second raised portion defining a trench therebetween; and;
a handle assembly having a handle body including a first end including a recess having a threaded counter bore configured to couple to a water source and a cavity formed in a top and middle portion, and a middle section, the middle section disposed between the handle body and the detail portion, and
wherein the cavity and the recess are in fluid communication.

13. The cleaning device of claim 12, wherein the handle assembly further comprises at least one gripping feature forming about a periphery of the handle body.

14. The cleaning device of claim 13, wherein each of the pair of fins define a slot therebetween.

15. The cleaning device of claim 13, wherein the detail portion is flexible.

16. The cleaning device of claim 12, the middle section further comprising:
a first end including a connecting portion;
a tube connected to the connecting portion and extending through the middle section in a longitudinal direction, along a longitudinal axis; and
a second end including a first protrusion and a second protrusion extending from the second end perpendicular to the longitudinal axis, the first protrusion and the second protrusion being diametrically opposed.

17. The cleaning device of claim 16, wherein the tube includes a tapered body.

18. The cleaning device of claim 16, wherein the tube, the cavity, and the recess are in fluid communication.

19. The cleaning device of claim 12 further comprising a flow regulator in fluid communication with the detail portion.

20. The cleaning device of claim 14, wherein each pair of fins is flexible.
